(19) United States
(12) Patent Application Publication
(10) Pub. No.: US 2025/0028281 A1
(43) Pub. Date: Jan. 23, 2025

(54) HOLOGRAPHIC DISPLAY USING METASURFACE AND METASURFACE OPTIMIZATION METHOD

(71) Applicant: SEOUL NATIONAL UNIVERSITY R&DB FOUNDATION, Seoul (KR)

(72) Inventors: Yoonchan JEONG, Seoul (KR); Seung-Woo NAM, Seoul (KR); Youngjin KIM, Seoul (KR); Dongyeon KIM, Seoul (KR)

(21) Appl. No.: 18/737,648

(22) Filed: Jun. 7, 2024

(30) Foreign Application Priority Data
Jul. 20, 2023 (KR) 10-2023-0094685

(51) Int. Cl. G03H 1/22; B82Y 20/00; G03H 1/00; G03H 1/32

(52) U.S. Cl. CPC G03H 1/2294; G03H 1/32; B82Y 20/00; G03H 2001/0088; G03H 2001/2207

(57) ABSTRACT

A holographic display using a metasurface and a metasurface optimization method are provided, wherein the holographic display includes a spatial light modulator, a half-wave plate configured to rotate a linear polarization direction of light incident from the spatial light modulator at a certain angle and output light including a horizontal linear polarization component and a vertical linear polarization component having a same magnitude and orthogonal to each other, and a metasurface including nanostructures configured to perform different phase modulations on the horizontal linear polarization component and the vertical linear polarization component, and the metasurface is optimized by using a gradient descent method.

### CROSS-REFERENCE TO RELATED APPLICATION

This application is based on and claims priority under 35 U.S.C. § 119 to Korean Patent Application No. 10-2023-0094685, filed on Jul. 20, 2023, in the Korean Intellectual Property Office, the disclosure of which is incorporated by reference herein in its entirety.

### BACKGROUND

### 1. Field

The disclosure relates to a holographic display, and more particularly, to a holographic display using a metasurface and a metasurface optimization method.

### 2. Description of the Related Art

FIG. 1 is a view illustrating an example of an existing holographic display. Referring to FIG. 1, a holographic display 100 may modulate a complex wavefront of a light wave by using a laser, which is a coherent light source, and a spatial light modulator (SLM) 110. Light, which is emitted through the spatial light modulator 110, may be propagated to form a three-dimensional image 120. Here, all light may have the same polarization, and thus, a reconstructed image 130 may be formed through interference of light.

Holographic displays, which may imitate light waves from real objects through wavefront modulation abilities described above and thus reconstruct three-dimensional images, have been in the spotlight as next-generation displays. One of major issues of holographic displays at present is image quality degradation due to speckle noise. Speckle noise is noise that appears when an image reconstructed with coherent light has a random phase distribution and refers to a grain-like noise caused by interference between neighboring pixels of a reconstructed image. In other words, general holographic displays use lasers that are coherent light sources, and thus, speckle noise appears and thus quality of images decreases.

Various methods have previously been provided to reduce speckle noise, and a representative example is a method of temporally overlapping holograms having several different speckle patterns. The same image is reconstructed by using a spatial light modulator that operates extremely quickly, but when holograms having different speckle patterns are displayed sequentially and quickly, eyes of a human recognize the holograms as one overlapping image, and thus, the different speckle patterns also overlap each other to reduce noise. In order to reduce speckle noise by using hologram overlapping as described above, holograms need to have characteristics of not interfering with each other. Even when several holograms, which may interfere with one another, overlap one another, an image may not be reconstructed on the basis of the average of the holograms, and new interference patterns and speckle patterns may be formed through interference between the holograms, and thus, a speckle noise reduction effect may not be expected. Existing holographic displays mainly use methods such as using spatial light modulators capable of operating at high speeds or using several light sources. However, the above methods have the shortcomings of using high-speed spatial light modulators that have not yet been commercialized or needing complex optical systems for using several light sources simultaneously.

### SUMMARY

Provide is a holographic display capable of reducing, by using a metasurface, speckle noise through a non-interference overlap between holograms having two polarization components that are orthogonal to each other.

Provide is a method of optimizing a metasurface of a holographic display that performs a non-interference overlap between holograms having two polarizations orthogonal to each other to reduce speckle noise.

Additional aspects will be set forth in part in the description which follows and, in part, will be apparent from the description, or may be learned by practice of the presented embodiments of the disclosure.

According to an aspect of the disclosure, a holographic display includes a spatial light modulator, a half-wave plate configured to rotate a linear polarization direction of light incident from the spatial light modulator at a certain angle and output light including a horizontal linear polarization component and a vertical linear polarization component having a same magnitude and orthogonal to each other, and a metasurface including nanostructures configured to perform different phase modulations on the horizontal linear polarization component and the vertical linear polarization component.

According to another aspect of the disclosure, a method of optimizing a metasurface for a holographic display by using a simulation model configured to model nanostructures of the metasurface, includes generating a reconstructed image by propagating a product of a complex wavefront of a spatial light modulator for a target image and a complex wavefront of the metasurface identified through the simulation model, calculating a value of a loss function indicating a difference between the reconstructed image and the target image, and optimizing patterns of the nanostructures of the metasurface in a direction in which the value of the loss function decreases, wherein the simulation model is a model indicating phase modulation values according to widths and lengths of respective rectangular parallelepipeds with respect to the nanostructures comprising a plurality of rectangular parallelepipeds arranged at equal pitches.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view illustrating an example of an existing holographic display;

FIG. 2 is a view illustrating an example of a holographic display according to an embodiment;

FIG. 3 is a view illustrating an example of a metasurface according to an embodiment;

FIG. 4 is a view illustrating another example of a holographic display according to an embodiment; and

FIGS. 5 and 6 are views illustrating an example of a method of optimizing a metasurface, according to an embodiment.

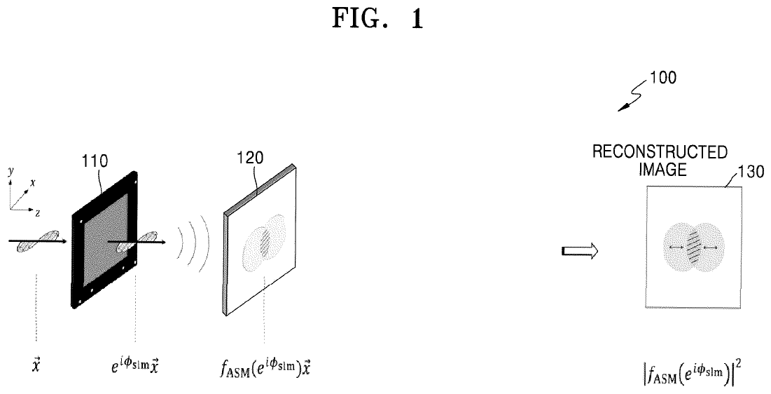

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, a holographic display using a metasurface and a metasurface optimization method according to an embodiment will be described in detail with reference to the accompanying drawings.

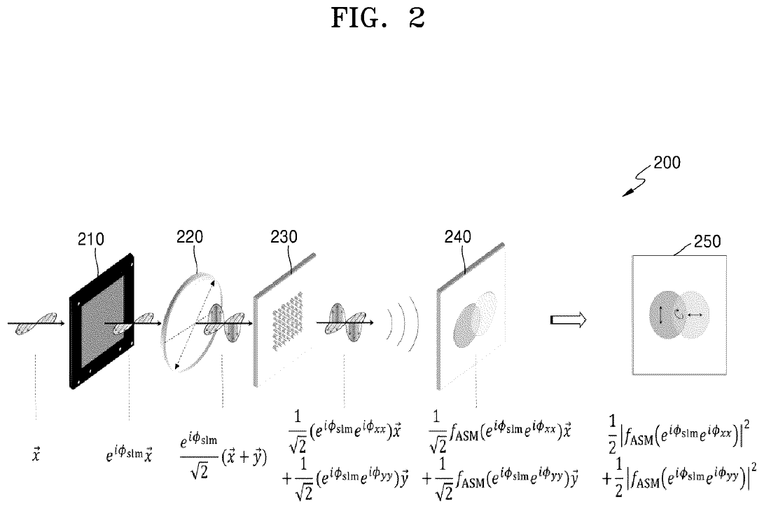

FIG. 2 is a view illustrating an example of a holographic display according to an embodiment.

Referring to FIG. 2, a holographic display 200 may include a spatial light modulator 210, a half-wave plate 220, and a metasurface 230. The holographic display 200 may implement holographic superimposition using a polarization channel by using the metasurface 230 having polarization selectivity.

The spatial light modulator 210 may modulate a phase of light emitted from a coherent light source (e.g., a laser). The spatial light modulator 210 may be a component widely used in a holographic display field, and thus, an additional description thereof is omitted.

The half-wave plate 220 may rotate a linear polarization direction of light incident from the spatial light modulator 210 at a certain angle (e.g., 45°). As a result, light output from the half-wave plate 220 may have a horizontal linear polarization component and a vertical linear polarization component that have the same size and are orthogonal to each other.

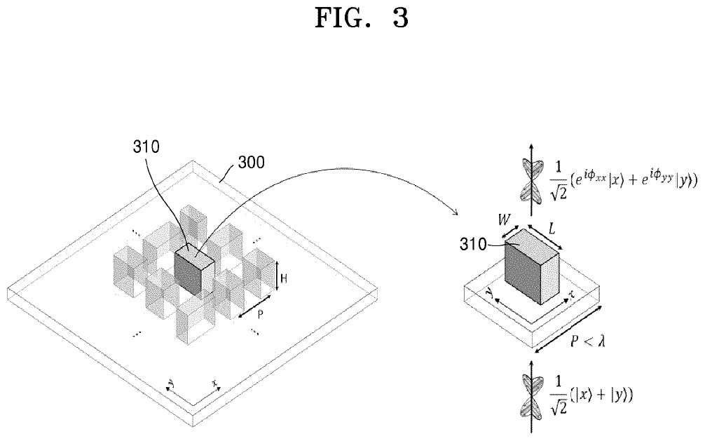

The metasurface 230 may include nanostructures that perform different phase modulations on the horizontal linear polarization component and the vertical linear polarization component. The horizontal linear polarization component and the vertical linear polarization component may propagate after undergoing different phase modulations while passing through the metasurface 230 that have the polarization selectivity and operates differently according to a polarization state. The arrangement and shape of the nanostructures for implementing the metasurface 230 having the polarization selectivity may be variously implemented according to embodiments. As an example, the metasurface 230, which is dependent on polarization, may be implemented by using rectangular parallelepiped nanostructures, and the description thereof is given again with reference to FIG. 3.

Light, which has two orthogonal polarization states differently phase-modulated through the metasurface 230, may reconstruct an image 240 having different speckle patterns. Light, which has two orthogonal polarization states propagated from the metasurface 230, may not interfere with each other due to a difference between the polarization states, and thus, when two images are superimposed on a reconstruction plane, an incoherent operation may be performed in which intensities of the images are combined without forming an interference pattern. In particular, when speckle patterns of two reconstructed images 250 are different from each other, noise may be reduced while the speckle patterns are superimposed in a non-interference manner, and thus, image quality may be improved.

In an equation shown in the picture of FIG. 2, \vec{x} and \vec{y} indicate linear polarizations in horizontal and vertical directions, respectively, φₛᵢₘ indicates a phase of a spatial light modulator, φₓₓ and φ_{yy} indicate phases of the metasurface 230 in x and y polarization directions, and f_{ASM} indicates a propagation model of light in a free space using an angular spectrum method (ASM).

FIG. 3 is a view illustrating an example of a metasurface according to an embodiment.

Referring to FIG. 3, a metasurface 300 may be an optical device in which nanostructures 310 having a less size than a wavelength are arranged. The metasurface 300 may change a phase, intensity, or polarization state of incident light through interaction between patterns of the nanostructures 310 and an electromagnetic wave. The metasurface 300 may have an extremely small thickness and a degree of freedom capable of modulating several characteristics of light and thus may be in the spotlight as a next-generation optical device. Optical properties of the metasurface 300 may be determined by a material constituting the nanostructures 310 and geometric structures and arrangement of the nanostructures 310.

Unlike most optical devices that perform the same operation regardless of a polarization direction of incident light, the metasurface 300 may be fabricated to perform different operations according to a polarization state of incident light by selecting an appropriate nanostructure 310.

In an embodiment, the metasurface 300 may include the nanostructures 310 constituted in rectangular parallelepipeds. The rectangular parallelepipeds may be arranged at regular pitches P and have the same height H. The optical properties of the metasurface 300 may be determined by adjusting a width W and a length L of a rectangular parallelepiped. For example, the metasurface 300 using a propagation phase may give independent phases to two linear polarizations (a horizontal polarization and a vertical polarization) orthogonal to each other by changing the width W and length L of the nanostructure 310 of the rectangular parallelepiped, and at this time, only a phase of light may be modulated while maintaining a polarization state when incident. In other words, the metasurface 300, which causes different phase modulations for a horizontal linear polarization component and a vertical linear polarization component, may be created by adjusting the length L and the width W of the rectangular parallelepipeds.

In contrast, the metasurface 300, which additionally uses a geometric phase, may enable independent phase modulations according to light in two circular polarization states (e.g., a left circular polarization and a right circular polarization) that are orthogonal to each other rather than linear polarizations by using a rotated rectangular parallelepiped nanostructure. In the case of the metasurface 300 using the geometric phase, the incident light may be converted into a polarization orthogonal to an original polarization (e.g., when a phase is modulated, a left circular polarization is changed to a right circular polarization and a right circular polarization is changed to a left circular polarization). A polarization-dependent operation as described above may enable operations that may not be easily implemented in an existing optical device, such as operating as a convex lens for one polarization and a concave lens for a polarization orthogonal thereto.

When any different phase modulations are applied to light in two orthogonal polarization states, polarization superimposition may occur, and thus, speckle noise may be reduced. However, when a pattern of an appropriate nanostructure 310 is selected, quality of a polarization-superimposed image may be further improved.

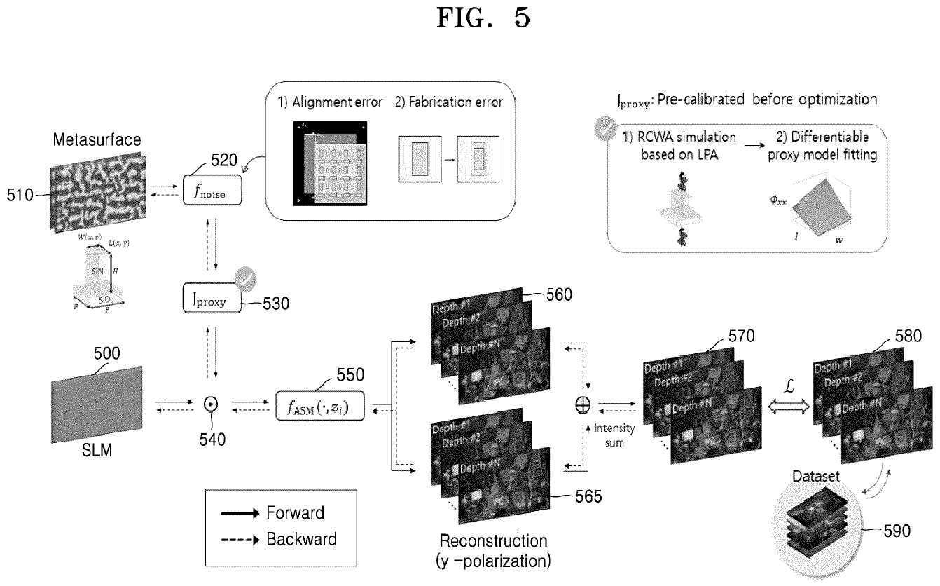

To this end, the metasurface 300 may be designed in a method of setting an appropriate loss function so that the metasurface 300 performs a desired function and optimizing geometric parameters of the nanostructures 310 to minimize the loss function through an electromagnetic wave simulation. A method of optimizing the metasurface 300 implemented by the nanostructures 310 of the rectangular parallelepipeds is described again with reference to FIG. 5.

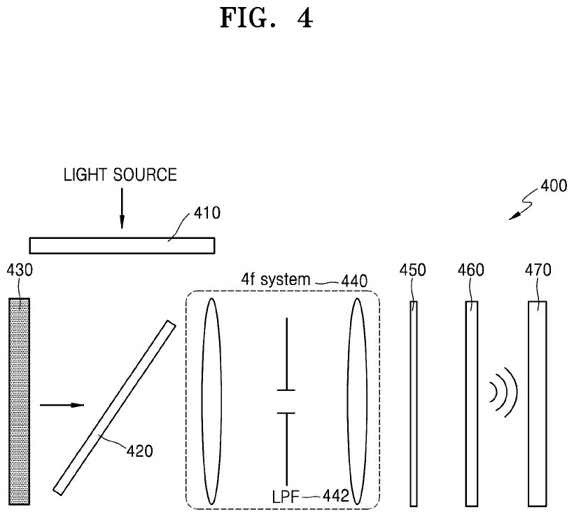

FIG. 4 is a view illustrating another example of a holographic display according to an embodiment.

Referring to FIG. 4, a holographic display 400 may include a linear polarizer (LP) 410, a beam splitter (BS) 420, a spatial light modulator 430, a 4-f system 440, a half-wave plate 450, and a metasurface 460. The spatial light modulator 430, the half-wave plate 450, and the metasurface 460 are the same as the components described with reference to FIG. 2.

Light, which is emitted from a light source, may pass through the linear polarizer 410 and be incident on the spatial light modulator 430 through the beam splitter 420. The spatial light modulator 430 may modulate a phase of the incident light and output the light having the modulated phase to the 4-f system 440.

The 4-f system 440 may be an optical system that intactly transmits an image on an incidence surface to an emission surface by using two lenses. When the image on the incidence surface is located at a distance f (focal length) from a first lens, the image on the incidence surface may be intactly transmitted to the emission surface at a location f (focal length) from a second lens. The 4-f system 440 of the present embodiment may further include a low-pass filter (LPF) 442 for filtering out a higher order diffraction term of the spatial light modulator 430.

While the light, which passes through the 4-f system 440, may pass through the half-wave plate 450, a polarization direction thereof may be rotated by 45° and the light may incident on the metasurface 460. The light, which passes through the metasurface 460, may form a reconstructed image 470. A linear polarization rotated by 45° may be expressed as the sum of a horizontal polarization and a vertical polarization of the same size, and thus may undergo different phase modulations while passing through the metasurface 460.

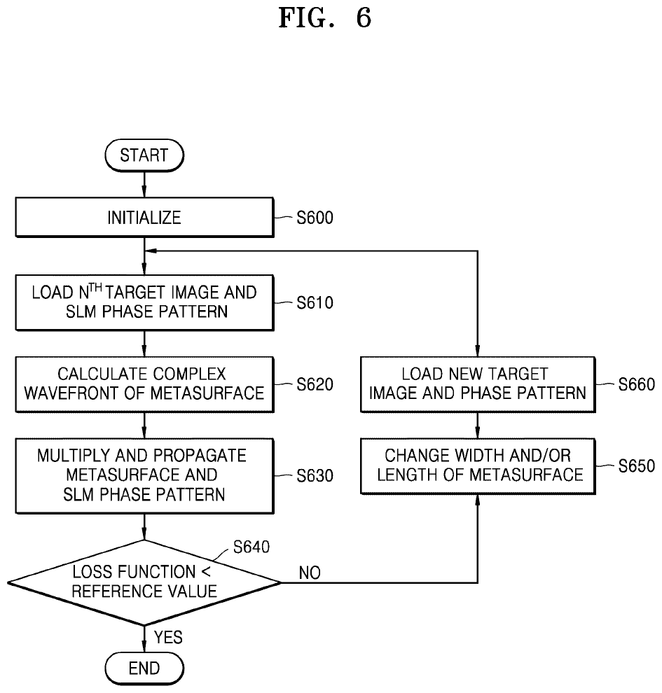

FIGS. 5 and 6 are views illustrating an example of a method of optimizing a metasurface, according to an embodiment.

The method of optimizing a metasurface may be performed by an optimization apparatus implemented as a computing apparatus including a memory, a processor, and an input/output device. For example, each component described with reference to FIGS. 5 and 6 may be implemented as software, loaded on the memory, and then performed by the processor.

The optimization apparatus may include a simulation model that models a nanostructure of a metasurface 510. In the present embodiment, the nanostructure of the metasurface 510 may be a rectangular parallelepiped as shown in FIG. 3. The metasurface 510 may include a plurality of rectangular parallelepipeds arranged at regular pitches, heights of the rectangular parallelepipeds may be all the same, and widths and lengths of the rectangular parallelepipeds may be adjusted. The simulation model may be a model indicating the degree of a phase modulation that incident light undergoes in each polarization direction according to the widths and lengths of the rectangular parallelepiped nanostructures of the metasurface 510. For example, a phase modulation according to the shape of rectangular parallelepiped nanostructures of a metasurface may be obtained through rigorous coupled-wave analysis (RCWA). In addition, various methods of obtaining the phase modulation according to the shape of the nanostructures of the metasurface may be applied to the present embodiment.

Through the simulation model, the optimization apparatus may identify the magnitude for the phase modulation of the incident light according to the widths and lengths of the rectangular parallelepipeds of the metasurface. For example, the simulation model may be approximately expressed as a polynomial representing phases φₓₓ and φ_{yy} for respective polarization directions x and y according to the width W and length L of the rectangular parallelepiped of the metasurface 510. The simulation model may be referred to as a proxy model of a metasurface structure and may be represented as J_{proxy} 530 in FIG. 5. The optimization apparatus may obtain, through the simulation model, a complex wavefront of light that passes through a metasurface.

Referring to FIGS. 5 and 6, in operation S600, the optimization apparatus may perform an initialization process. For example, the optimization apparatus may provide a dataset 590 including at least one target image. The dataset 590 may include a phase pattern for the target image. The target image may be an image to be reconstructed through a holographic display. When the simulation model obtained as the proxy model and the dataset 590 are provided, the optimization apparatus may perform an optimization process for the metasurface 510. As another example, the optimization apparatus may initialize geometric patterns of nanostructures of a metasurface to a uniform random distribution.

The optimization apparatus may obtain a complex wavefront of the spatial light modulator 500 for the target image in operation S610, obtain a complex wavefront of the metasurface 510 identified through the simulation model in operation S620, and propagate a Hadamard product 540 of the two complex wavefronts to generate a reconstructed image 570 in operation S630. For example, the optimization apparatus may obtain a complex wavefront of the spatial light modulator 500 for a phase pattern corresponding to the target image by using a mathematical model of the spatial light modulator 500. The mathematical model of the spatial light modulator 500 may be a method widely used in a computer-generated hologram (CHG) or the like, and thus, an additional description thereof is omitted.

In the embodiments of FIGS. 2 and 4, a half-wave plate and the metasurface 510 may be sequentially located behind the spatial light modulator 500, but when a gap between the half-wave plate and the metasurface 510 is extremely small, the spatial light modulator 500 and the metasurface 510 may be considered to be present on the same plane. Therefore, the proxy model J_{proxy} 530 of FIG. 5 may represent a wavefront modulated to different phases according to two polarization directions by the Hadamard product 540 of the complex wavefront of the spatial light modulator 500 and the complex wavefront of the metasurface 510.

In another embodiment, the optimization apparatus may consider noise when obtaining the complex wavefront of the metasurface 510. The metasurface 510, which is actually implemented, may have nanostructures greater or smaller than an intended value due to swelling and shirking, and unlike being assumed on a simulation, the nanostructures may not be completely disposed on the metasurface 510. After defining a noise function fₙₒᵢₛₑ 520 representing such noise, the optimization apparatus may obtain the complex wavefront of the metasurface 510 by multiplying an output value of the simulation model by the noise function fₙₒᵢₛₑ 520. Therefore, when actually implementing the metasurface 510 identified through the optimization process, a sufficient polarization superimposition effect may be exhibited even when a certain degree of error occurs.

In operation S640, the optimization apparatus calculates a value of a loss function indicating a difference between the reconstructed image 570 and a target image 580. In an embodiment, the optimization apparatus may generate the reconstructed image 570 which is generated by propagating 550 light through a free space by using an angular spectrum method (ASM). A method of generating a reconstructed image by propagating a complex wavefront to a reconstruction plane by using an ASM is already a widely known method, and thus, a detailed description thereof is omitted.

The optimization apparatus may generate respective images 560 and 565 on wavefronts modulated to different phases according to two polarization directions, and thus may finally calculate the reconstructed image 570 by adding intensities of the images 560 and 565 respectively generated through two orthogonal polarizations. The loss function may be a function indicating a difference between respective pixels of the reconstructed image 570 and the target image 580, and in addition, various types of existing loss functions may be applied to the present embodiment.

The optimization apparatus may optimize patterns of the nanostructures of the metasurface 510 in a direction in which a value of the loss function decreases. In an embodiment, the optimization apparatus may optimize the metasurface 510 by repeatedly performing a process of updating widths and lengths of rectangular parallelepipeds of the metasurface 510 by using a gradient descent method until the loss function converges. The optimization apparatus may repeatedly perform a process of optimizing the metasurface 510 by using a plurality of target images 580 present in a dataset 590. For example, when the value of the loss function is greater than a predefined reference value, in operation S650, the optimization apparatus may update the widths and lengths of the rectangular parallelepipeds of the metasurface 510 by using the gradient descent method. The optimization apparatus may load a new target image in operation S660, obtain a reconstructed image again by using the updated metasurface in operations S610, S620, and S630, and obtain a loss function between the reconstructed image 570 and the target image 580. In operation S640, the optimization process may be repeatedly performed until the value of the loss function becomes smaller than the predefined reference value.

In another embodiment, the optimization apparatus may optimize together various parameters such as the shape of the nanostructures of the metasurface 510 as well as a material constituting the metasurface 510, a propagation distance of a hologram, and a wavelength of a light source.

The present embodiment mainly describes the process of optimizing the metasurface 510. In another embodiment, the optimization apparatus may optimize a phase pattern together with the metasurface 510. For example, when the value of the loss function is greater than the predefined reference value, the optimization apparatus may obtain the loss function by updating the widths and lengths of the rectangular parallelepipeds of the metasurface 510, updating the phase pattern together, obtaining the complex wavefront of the spatial light modulator 500 and the complex wavefront of the metasurface 510 on the basis of the updated metasurface and the updated phase pattern, generating the reconstructed image 570, comparing the reconstructed image 570 with the target image 580. Until the value of the loss function becomes less than the predefined reference value, the optimization apparatus may optimize the loss function by repeatedly performing the process of updating the metasurface and the phase pattern through the gradient descent method.

According to an embodiment, speckle noise of a holographic display may be reduced and quality of an image may be improved through a polarization superimposition of a hologram by using a polarization-dependent metasurface. In addition, compared to an existing holographic display, a peak signal-to-noise ratio (PSNR) may increase and a speckle contrast may decrease. Here, the speckle contrast indicating an intensity of speckle noise may be expressed as a ratio of variance and average of an image intensity, and when the speckle contrast is higher, the speckle noise may be severe and when the speckle contrast is lower (i.e., closer to zero), the speckle noise may be less.

The disclosure may also be implemented as computer-readable program code on a computer-readable recording medium. The computer-readable recording medium includes all types of recording devices in which data readable by a computer system is stored. Examples of the computer-readable recording medium include ROM, RAM, CD-ROM, a magnetic tape, a floppy disk, an optical data storage device, and the like. In addition, the computer-readable recording medium may be distributed in a network-connected computer system so that computer-readable code may be stored and executed in a distributed manner.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A holographic display comprising:
a spatial light modulator;
a half-wave plate configured to rotate a linear polarization direction of light incident from the spatial light modulator at a certain angle and output light comprising a horizontal linear polarization component and a vertical linear polarization component having a same magnitude and orthogonal to each other; and
a metasurface comprising nanostructures configured to perform different phase modulations on the horizontal linear polarization component and the vertical linear polarization component.

2. The holographic display of claim 1, wherein the nanostructures of the metasurface comprise a plurality of rectangular parallelepipeds arranged at regular pitches, the plurality of rectangular parallelepipeds have a same height, and all or some of the plurality of rectangular parallelepipeds have different widths and lengths for a polarization-dependent phase modulation.

3. The holographic display of claim 1, further comprising a 4-f system located between the spatial light modulator and the half-wave plate.

4. The holographic display of claim 3, wherein the 4-f system comprises a low-pass filter configured to filter out a higher order diffraction term of the spatial light modulator.

5. A method of optimizing a metasurface for a holographic display by using a simulation model configured to model nanostructures of the metasurface, the method comprising:
generating a reconstructed image by propagating a product of a complex wavefront of a spatial light modulator for a target image and a complex wavefront of the metasurface identified through the simulation model;
calculating a value of a loss function indicating a difference between the reconstructed image and the target image; and
optimizing patterns of the nanostructures of the metasurface in a direction in which the value of the loss function decreases, wherein the simulation model is a model indicating phase modulation values according to widths and lengths of respective rectangular parallelepipeds with respect to the nanostructures comprising a plurality of rectangular parallelepipeds arranged at equal pitches.

6. The method of claim 5, wherein the optimizing comprises repeatedly performing a process of updating patterns of the nanostructures until the value of the loss function converges within a certain range by using a gradient descent method.

7. The method of claim 5, wherein the optimizing comprises updating and optimizing the patterns of the nanostructures of the metasurface and a phase pattern of the spatial light modulator together.

8. The method of claim 5, wherein the complex wavefront of the metasurface is generated by multiplying an output value of the simulation model according to the patterns of the nanostructures by a predefined noise function.

9. The method of claim 5, wherein the generating of the reconstructed image comprises:
obtaining a wavefront in an x-polarization direction and a wavefront in a y-polarization direction by multiplying the complex wavefront of the spatial light modulator and the complex wavefront of the metasurface; and
generating the reconstructed image by adding intensities of images reconstructed by propagating the wavefront in the x-polarization direction and the wavefront in the y-polarization direction, respectively.

10. The method of claim 5, wherein a phase modulation value of the simulation model is identified through a rigorous coupled-wave analysis (RCWA) simulation.

11. A computer-readable recording medium having recorded thereon a computer program for performing the method of claim 5.
